(19) United States
(12) Patent Application Publication
(10) Pub. No.: US 2005/0199677 A1
(43) Pub. Date: Sep. 15, 2005

(54) Wire bonding apparatus having actuated flame-off wand

(75) Inventors: Richard Sadler, Quakertown, PA (US); James E. Eder, Doylestown, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Kulicke and Soffa Industries Inc.

(21) Appl. No.: 11/075,236

(22) Filed: Mar. 8, 2005

Related U.S. Application Data
(60) Provisional application No. 60/551,739, filed on Mar. 9, 2004.

(51) Int. Cl. B23K 37/00

(52) U.S. Cl. 228/4.5

(57) ABSTRACT

A wire bonding machine is provided which includes a bond head including a wire bonding tool adapted to feed a wire for bonding to bonding locations. The wire bonding machine also includes an electronic flame-off wand configured to heat an end portion of the wire extending through the bonding tool to form a free-air ball for bonding. The electronic flame-off wand is vertically actuatable relative to a support structure of the electronic flame-off wand.

### RELATED APPLICATION

This application is related to and claims priority from U.S. Provisional Application 60/551,739, filed Mar. 9, 2004, the disclosure of which is incorporated herein by reference in its entirety.

### FIELD OF THE INVENTION

The present invention relates to wire bonding, and more particularly to a wire bonding apparatus having an electronic flame-off wand for forming a free-air ball.

### BACKGROUND OF THE INVENTION

In the electronics industry, conductive metal wire is used in a variety of devices (e.g., semiconductor devices), for example, to provide electrical interconnection between portions of a device. The most commonly used materials for wire bonding are gold and aluminum. Copper and silver are also used. A wire bond is formed by attaching a length of wire between two contact locations. In order to form the attachment, various devices are used to sever and bond (e.g., weld) the wire ends to the contact location. Known devices include thermocompression (T/C), thermosonic (T/S) and ultrasonic (U/S) devices. The resulting length of bonded wire is typically curved along its length in a generally parabolic or elliptical configuration and is, therefore, referred to as a wire “loop”.

Two well known techniques for bonding wire to a contact location are ball bonding and wedge bonding. Ball bonding is generally the preferred technique, particularly in the semiconductor industry. Referring to FIG. 1, a known apparatus using ball bonding includes a bond head 10 carrying a device known as a capillary 12 through which a length of the metal wire is fed.

Ball bonding apparatuses also include an electronic flame-off (EFO) wand 14 that, when fired, cause a spark to jump from an end of the EFO wand to an end position of the wire extending from the capillary 12 causing the wire to melt. As the molten end portion of the wire solidifies, surface tension forms the end portion into a substantially spherical shape. The spherically shaped portion of the wire formed by the EFO wand is referred to as a “free-air ball”. The free-air ball of a wire loop, and an opposite tail end of the wire loop, are bonded to respective contact locations (e.g., bonding pads on a die, chip, substrate, interconnect structure, etc.). For example, the bonding between a wire and a bond pad of a substrate is caused by plastic deformation and interfacial interaction of the two metal surfaces that results from a combination of force and temperature, as well as ultrasonic energy if the apparatus includes a transducer device.

In order to move the workpiece (e.g., substrate being bonded) into the proper location for the bonding operation, conventional wire bonding machines are typically used in conjunction with material handling systems that move substrates into and out of a bonding site to position a bond plane 16 defined by the substrate device in the bonding site. The bond plane 16 is shown in the figures as having a vertical (i.e., z-axis) location of zero (0.000 inches). A clamp insert 18 is used to lock substrate devices in position at the bonding site for wire bonding. The clamp insert 18 is raised and lowered between “open” and “closed” positions, as shown in FIG. 1 by arrow A, when electronic devices are delivered to the bonding site and when the devices are subsequently removed from the bonding site. As shown in FIG. 1, in one conventional wire bonding machine, the clamp insert 18 is moved vertically between the open and closed positions a distance of approximately 0.074 inches.

The bond head 10 of known wire bonding apparatuses, which carries the bonding tool (e.g., capillary 12), is actuated vertically at the bonding site, as shown by Arrow B, to raise and lower the capillary 12 with respect to the bond plane 16. The EFO wand 14 of conventional wire bonding machines, however, are statically located at a fixed distance above the bond plane 16. Because it remains static, the EFO wand 14 must be located at a sufficient distance above the bond plane 16 to avoid interference between the EFO wand 14 and the clamp insert 18 when the insert 18 is moved to its open position. For example, as shown in FIG. 1, the EFO wand 14 of one conventional device is statically located at a distance of 0.270 inches above the bond plane 16.

As described above, the EFO wand 14 is fired to melt an extending end portion of the wire and form a free-air ball for each loop that is applied by the wire bonding apparatus. Therefore, the bond head 10 of the prior art apparatus will need to raise the capillary 12 to a sufficient distance above the EFO wand 14, which is statically located at 0.270 inches, in order to properly locate the wire adjacent the EFO wand 14 for formation of a free-air ball. As shown in FIG. 2, the bond head 10 of one conventional machine must be raised vertically a distance of approximately 0.320 inches above the bond plane 16 for each wire loop that is to be applied to a given substrate device.

### SUMMARY OF THE INVENTION

According to an exemplary embodiment of the present invention, a wire bonding machine is provided. The wire bonding machine includes a bond head including a wire bonding tool adapted to feed a wire for bonding to bonding locations. The wire bonding machine also includes an electronic flame-off wand configured to heat an end portion of the wire extending through the bonding tool to form a free-air ball for bonding. The electronic flame-off wand is vertically actuatable relative to a support structure of the electronic flame-off wand.

According to another exemplary embodiment of the present invention, an electronic flame-off wand configured to heat an end portion of a wire extending through a bonding tool of a wire bonding machine to form a free-air ball for bonding is provided. The electronic flame-off wand includes a support structure, a wand supported by the support structure, and an actuator configured to vertically adjust a position of the wand with respect to the support structure.

According to yet another exemplary embodiment of the present invention, a method of operating an electronic flame-off wand configured to heat an end portion of a wire extending through a bonding tool of a wire bonding machine to form a free-air ball for bonding is provided. The method includes lowering a clamp insert of a wire bonding machine to secure a device to be wirebonded. The method also includes lowering, using an actuator, the electronic flame-off wand towards the clamp insert while the clamp insert secures the device to be wirebonded.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown. In the drawings:

FIG. 1 is a side view illustrating a prior art wire bonding apparatus and showing a clamp insert in an open position.

FIG. 2 is a side view of the prior art wire bonding apparatus of FIG. 1 showing the clamp insert in a closed position and showing the bond head of the apparatus positioned for forming a free-air ball at the end of a wire loop.

FIG. 3 is a side view illustrating a wire bonding apparatus according to an exemplary embodiment of the present invention and showing a clamp insert in an open position and the EFO wand of the apparatus in a raised position.

FIG. 4 is a side view of the wire bonding apparatus of FIG. 3 showing the clamp insert in a closed position, the EFO wand in a lowered position and the bond head of the apparatus positioned for forming a free-air ball at the end of a wire loop.

FIG. 5 is a perspective view of a solenoid-actuated EFO wand assembly according to an exemplary embodiment of the present invention.

FIG. 6 is a perspective view of a solenoid-actuated EFO wand assembly according to an exemplary embodiment of the present invention having a return spring.

FIG. 7 is a partial perspective view of an EFO wand and clamp insert according to an exemplary embodiment of the present invention.

FIG. 8 is a flow diagram illustrating a method of operating an electronic flame-off wand in accordance with an exemplary embodiment of the present invention.

### DETAILED DESCRIPTION OF THE DRAWINGS

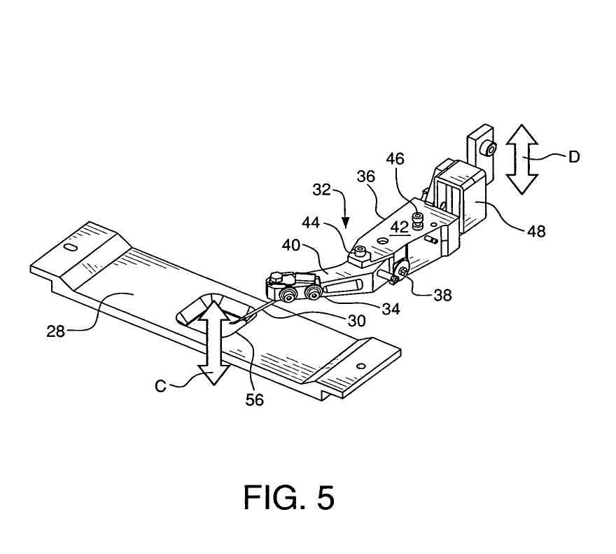

As used herein, the term “support structure”, with regard to an electronic flame-off wand, refers to any structure (e.g., housing 36 illustrated in FIG. 5) configured to support the electronic flame-off wand. For example, the support structure may pivotally support the electronic flame-off wand via a wand support arm (e.g., about a pivot bearing) to provide for vertical actuation of the wand relative to the support structure; however, the support structure is not limited to such an embodiment. For example, the support structure may support the electronic flame-off wand using a linear bearing via a wand support arm. As such, the support structure (and its interconnection to the wand, for example, through a wand support arm) is not limited to any particular configuration.

Likewise, in embodiments of the present invention including a wand support arm, the “wand support arm” is not limited to the details illustrated in the figures and described herein. Rather, the wand support arm may include any structure between the support structure and the electronic flame-off wand.

As used herein, the terms “actuatable” or “actuated” refer to the electronic flame-off wand being vertically adjustable by an actuator during the bonding operation so that the wand may be raised and lowered with respect to a bonding plane.

According to an exemplary embodiment of the present invention, a wire bonding apparatus for bonding a wire between bonding locations on semiconductor elements (e.g., dies, chips, substrates, etc.) is provided. The wire bonding apparatus includes a bond head carrying a capillary adapted for bonding a metal wire to bonding locations. The wire bonding apparatus is a ball bonding apparatus and includes an electronic flame-off (EFO) wand adapted for melting a terminal end portion of the wire extending from the capillary to form the end portion into a free-air ball.

The EFO wand of the present invention is vertically actuatable with respect to the bond plane between raised and lowered positions. The raised position of the EFO wand is selected to prevent interference between the EFO wand and a clamp insert located at the bonding site. The clamp insert is designed to be raised and lowered between open and closed positions to permit receipt of an electronic device at the bonding site and its ejection therefrom after wire loops are applied to the device.

The lowering of the EFO wand from its raised position is accommodated by the lowering of the clamp insert from its open position to its closed position. The lowered position of the EFO wand is selected to avoid interference between the EFO wand and the closed clamp insert. Because of the vertical actuation of the EFO wand, the distance that the capillary is raised by the bond head to form a free-air ball during each wire loop applied at the bond site is reduced by approximately 23 percent (i.e., from 320 mils to 246 mils) from that for prior art wire bonding machines with statically supported EFO wands. The reduced travel distance required for the bond head provides for substantial reduction in wire loop cycle time, thereby increasing the overall machine throughput as well as providing for reduced motor heating for the bond head drive system, thereby improving overall machine accuracy.

In certain embodiments of the present invention, because the EFO wand may be raised, the clamp may be raised in the open position to provide more clearance for bonded wire loops on a device that has been wirebonded during the ejection process without increasing the bond head travel during looping.

According to one embodiment of the invention, a wand assembly includes a pivotably supported wand-support arm that carries an EFO wand adjacent one end of the arm. The arm assembly also includes a solenoid engaging the wand-support arm to move the EFO wand between “up” and “down” positions. The wand assembly may also include a return spring engaging the wand-support arm for urging the EFO wand towards the “up” position (i.e., the power off condition).

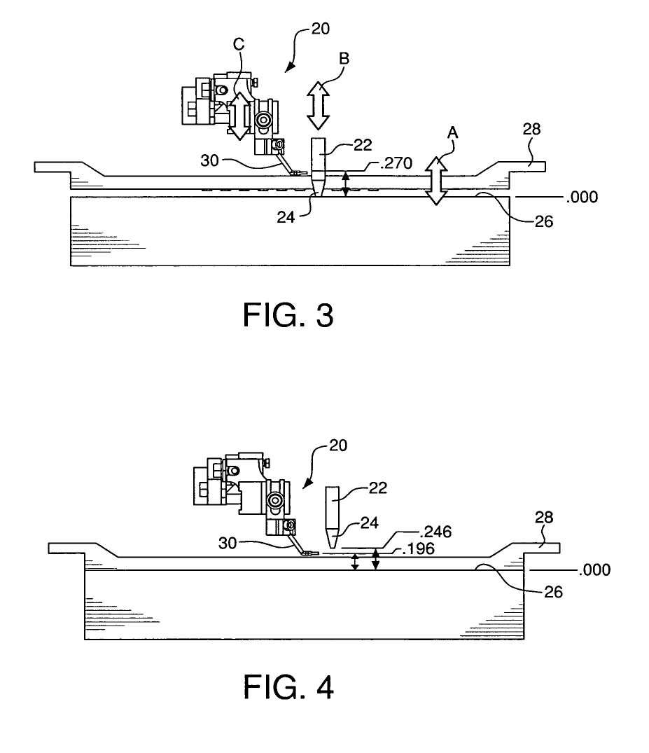

Referring to the drawings, where like numerals identify like elements, there is illustrated in FIGS. 3 and 4 a wire bonding apparatus 20 according to an exemplary embodiment of the present invention. The wire bonding apparatus 20 includes a bond head 22 carrying a bonding tool 24 (e.g., capillary 24) that feeds metal wire for forming wire loops to be bonded to a bonding location, such as a contact pad of an integrated circuit, for example. The wire bonding apparatus 20 is located at a bonding site that receives substrate devices delivered by a material handling system (not shown). The bond head 22 is configured to be raised and lowered, as shown by Arrow B, at the bonding site with respect to at least one bond plane 26 defined by a substrate device. The raising and lowering of the bond head 22 provides for bonding of wire ends delivered by the capillary 24 onto the bond plane 26. The bonding of the wire ends forms loops.

A clamp insert 28 is located at the bonding site and is designed to be raised and lowered, as shown by Arrow A, between open and closed positions to lock a substrate device in position at the bonding site for bonding of wire loops on the bond plane 26. The open and closed positions for the clamp insert 28 are respectively shown in FIGS. 3 and 4.

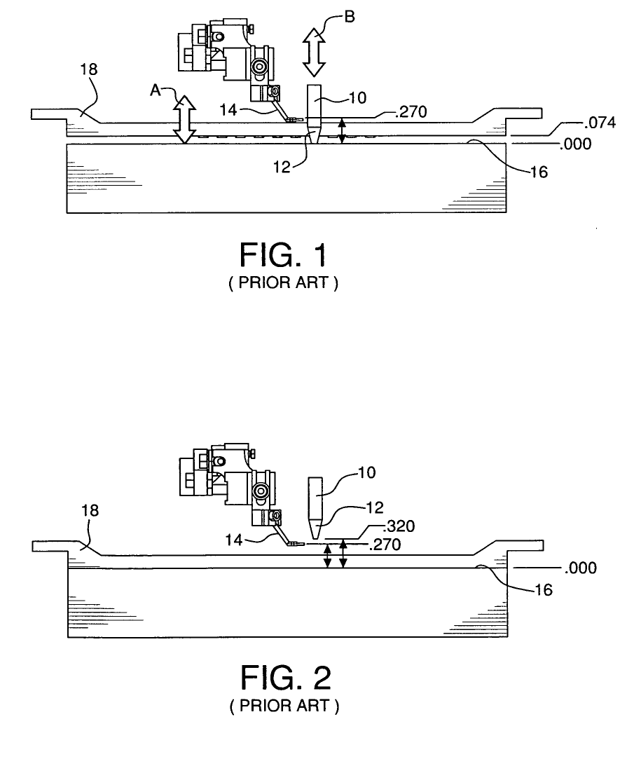

The wire bonding apparatus 20 is a ball bonding apparatus and includes an electronic flame-off (EFO) wand 30 that is designed to be fired to melt an end portion of a metal wire extending from the capillary 24 to form a free-air ball. In contrast to the EFO wands of prior art wire bonding machines (e.g., FIGS. 1-2), which are statically located at a fixed z-axis distance relative to the bond plane, the EFO wand 30 of the present application is vertically actuated, as shown by Arrow C (FIG. 3). That is, the EFO wand can be raised and lowered with respect to the bond plane 26. The EFO wand 30 is shown in FIG. 3 in a raised position at a z-axis distance of approximately 0.270 inches above the bond plane 26. Location of the EFO wand 30 at this distance avoids interference between the EFO wand 30 and the clamp insert 28 when the clamp insert 28 is in its open position during receipt of an electronic device into the bonding site or during its removal therefrom.

Referring to FIG. 4, the EFO wand 30 is shown in a lowered position. Because the clamp insert 28 has been lowered to its closed position, the EFO wand 30 can be lowered below the z-axis distance of 0.270 inches without resulting interference between the EFO wand 30 and the clamp insert 28. As shown, the EFO wand 30 in its lowered position is located at a z-axis distance of 0.196 inches. As such, the present invention reduces the height above the bond plane that the ball is formed for subsequent bonding. During formation of the free-air ball using the exemplary embodiment of the present invention illustrated in FIGS. 3-4, the bond head 22 of wire bonding apparatus 20 only raises the capillary 24 from the bond plane 26 to a z-axis distance of approximately 0.246 inches above the bond plane 26 as shown in FIG. 4 in order to permit the EFO wand to form the next ball.

According to the exemplary embodiment of the present invention illustrated in FIGS. 3-4, Since the vertical positioning control of the EFO wand 30 of the present invention permits a ball formation at a lower height relative to the bond plane, the distance that the bond head 22 of wire bonding apparatus 20 travels during the formation of each wire loop is reduced by approximately 23 percent (i.e., (0.320-0.246)/0.320) as compared to the movement of conventional wire bonding machines. This reduction in bond head travel distance during each loop formation correlates directly with a substantial reduction in cycle time. Thus, more product output is possible utilizing the present invention. This is particularly evident for relatively short wire loops where the z-axis movement of the bond head is a limiting factor.

The reduction in bond head travel distance provided by the present invention also results in reduction in z-axis motor heating for the drive system of bond head 22. Wire bonding apparatuses sometimes incorporate compliant guidance mechanisms that provide for a certain amount of flexure. The reduction in required travel distance for the bond head 22 during each looping cycle provided by the present invention, therefore, also serves to reduce fatigue otherwise imposed on linkages of such compliant guidance mechanisms, thus increasing the overall life of the machine.

By reducing a reset distance traveled by the bond head 22 between each looping cycle for free-air ball formation, the present invention also facilitates improved quality control for the resulting loops formed by the wire bonding apparatus. The lowering of the EFO wand reduces the amount of wire that must be taken up by the wire tensioning system during the motion from the 2^{nd} bond tear height to the EFO fire height. In the prior art, the wire can sometimes become damaged due to excessive buckling and bowing during the high speed motion.

Referring to FIG. 5, there is shown a solenoid-actuated EFO wand assembly 32 according to an exemplary embodiment of the present invention. The wand assembly 32 includes a wand-support arm 34 that supports an EFO wand 30 adjacent an end of the arm 34 to form free-air balls at the end of a metal wire carried by a bond head, such as bond head 22 shown in FIGS. 3 and 4. The wand-support arm 34 is, in turn, received within a cavity defined by an arm housing 36 and is pivotably connected to the housing 36, preferably by a pivot bearing 38 (e.g., a bronze pivot bearing).

The wand-support arm 34 is connected to the arm housing 36 such that a gap is defined between an upper surface 40 of the wand-support arm 34 and a top wall 42 of the arm housing 36. This gap allows for pivoting of the wand-support arm 34 with respect to the arm housing 36 about a pivot axis defined by the pivot bearing 38 to raise and lower the EFO wand 30 that is carried by the wand-support arm 34. The EFO wand 30 is moved by the pivoting support-arm 34 between an “up” position, in which the EFO wand 30 is raised with respect to a clamp insert 28, and a “down” position, in which the EFO wand 30 is located at its operating location where it forms the free-air balls.

The wand assembly 32 further includes first and second stop members 44, 46 respectively connected to the top wall 42 of the arm housing 36 forwardly and rearwardly of the pivot bearing 38. Located in this manner, the stop members 44, 46 are contacted by the upper surface 40 of the wand-support arm 34 to respectively establish the “up” and “down” positions for the EFO wand 30. Each of the stop members 44, 46 is preferably threadedly engaged with the top wall 42 of the arm housing 36 to provide for adjustment of the “up” and “down” limit positions.

The wand assembly 32 further includes a solenoid 48 located at a rearward end of the arm housing 36 which engages with an end of the wand-support arm 34 opposite the end of the arm 34 that carries the EFO wand 30. Vertical actuation of the rearward end of the wand-support arm 34 by the solenoid 48, illustrated in FIG. 5 by arrow D, results in vertical actuation of the forward end of the wand-support arm 34, illustrated in FIG. 5 by arrow C. The actuation of the wand-support arm 34 by the solenoid 48 is a see-sawing motion in which upward movement of the rearward end of the wand-support arm 34 results in downward movement of the opposite forward end, and vice-versa.

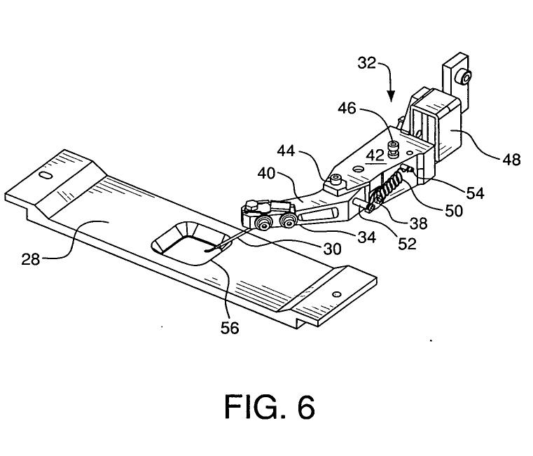

As shown in FIG. 6, the wand assembly 32 may also include a return spring 50 secured at opposite ends to posts 52, 54 respectively carried by the wand-support arm 34 and the arm housing 36. In contrast to the arrangement of FIG. 5, in which the solenoid functions to both raise and lower the rearward end of the wand-support arm 34, the return spring 50 of FIG. 6 urges the forward end of the wand-support arm 34 towards the “up” position for the EFO wand 30, thereby requiring actuation of the solenoid 48 only for moving the wand-support arm 34 to the “down” position.

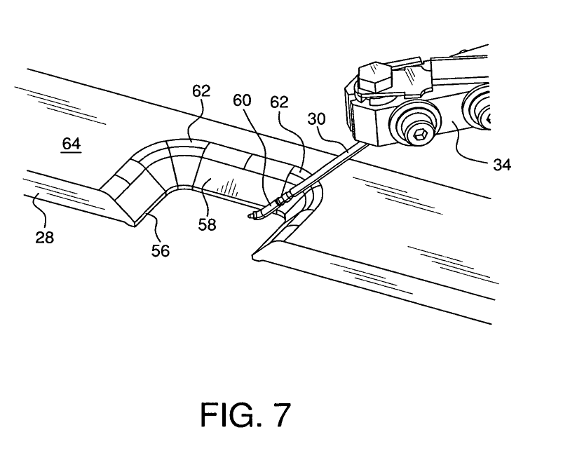

Referring to the partial perspective view of FIG. 7, the clamp insert 28 and EFO wand 30 are preferably adapted to limit arcing between them. The clamp insert 28 includes a substantially rectangular opening 56 that provides access for a bond head 22 (see FIGS. 3 and 4) for looping of wire onto a workpiece (e.g., a semiconductor element such as a die, chip, substrate, interconnect structure, etc.) secured by the clamp insert 28 in its closed position. As shown in FIG. 7, the sidewalls 58 of the opening 56 are angled to accommodate the EFO wand 30, which is preferably supported by the wand-support arm 34 at a substantially corresponding angle when the EFO wand 30 is located in its “down” position. The EFO wand 30 preferably includes electrical insulation 60 to limit arcing with the clamp insert 28. As shown in FIG. 7, the sidewalls 58 of the opening 56 also include radiused edges 62 adjacent the upper surface 64 of the clamp insert 28 to further limit the potential for arcing between the clamp insert 28 and the EFO wand 30 when the EFO wand 30 is located in its “down” position.

The present invention is not limited to vertical actuation of the EFO wand 30 by a solenoid as described above. A non-limiting list of other suitable means for vertically actuating the EFO wand 30 includes pneumatic, hydraulic, voice coil, DC motor, AC motor, or stepper motor means. The present invention is also not limited to the above-described pivoting arm 34 for vertically moving the EFO wand 30 between “up” and “down” positions.

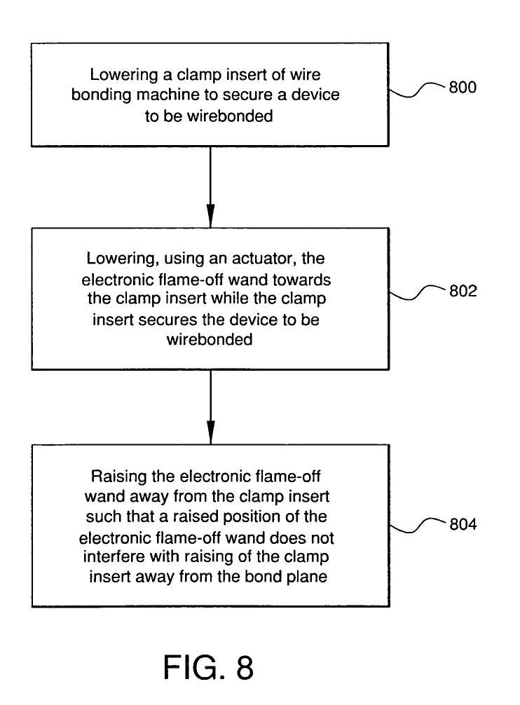

FIG. 8 is a flow diagram illustrating a method of operating an electronic flame-off wand configured to heat an end portion of a wire extending through a bonding tool of a wire bonding machine to form a free-air ball for bonding. As illustrated in FIG. 8, a clamp insert (i.e., any structure for securing a device to be wirebonded) of a wire bonding machine is lowered at step 800 to secure a device to be wirebonded. At step 802, the electronic flame-off wand is lowered, using an actuator, towards the clamp insert while the clamp insert secures the device to be wirebonded. At step 804, the electronic flame-off wand is raised away from the clamp insert such that a raised position of the electronic flame-off wand does not interfere with raising of the clamp insert away from the bond plane. The method may include other steps as described above with respect to the other embodiments of the present invention.

The method described above with respect to FIG. 8 (with or without additional steps as described above) may be implemented in a number of alternative mediums. For example, the method may be installed on an existing computer system/server as software (a computer system used in connection with, or integrated with, a wire bonding machine). Further, the method may operate from a computer readable carrier (e.g., solid state memory, optical disc, magnetic disc, radio frequency carrier medium, audio frequency carrier medium, etc.) that includes computer instructions (e.g., computer program instructions) related to the method of operating an electronic flame-off device.

The foregoing describes the invention in terms of embodiments foreseen by the inventor for which an enabling description was available, notwithstanding that insubstantial modifications of the invention, not presently foreseen, may nonetheless represent equivalents thereto.

1. A wire bonding machine comprising:
a bond head including a wire bonding tool adapted to feed a wire for bonding to bonding locations; and
an electronic flame-off wand configured to heat an end portion of the wire extending from the bonding tool to form a free-air ball for bonding, the electronic flame-off wand being vertically actuatable relative to a support structure of the electronic flame-off wand.

2. The wire bonding machine according to claim 1, wherein the electronic flame-off wand is pivotably connected to the support structure via a wand support arm.

3. The wire bonding machine according to claim 2 further comprising an actuator for vertically adjusting a position of the electronic flame-off wand by pivoting the wand-support arm with respect to the support structure.

4. The wire bonding machine according to claim 3 wherein the actuator comprises a solenoid.

5. The wire bonding machine according to claim 3 wherein the actuator is configured to adjust a position of the electronic flame-off wand between a raised and a lowered position.

6. The wire bonding machine according to claim 5 wherein the raised position is predetermined such that when the electronic flame-off wand is in the raised position the electronic flame-off wand does not interfere with raising of a clamp insert of the wire bonding machine above a bonding plane of the wire bonding machine, and the lowered position is predetermined such that when the electronic flame-off wand is in the lowered position the electronic flame-off wand does not interfere with the clamp insert securing a device to be wirebonded.

7. The wire bonding machine according to claim 3 further comprising a spring for urging the electronic flame-off wand toward a raised position when the actuator is not being actuated, the actuator being configured to lower the electronic flame-off wand when the actuator is being actuated.

8. The wire bonding machine of claim 1 additionally comprising a clamp insert for securing a device to be wirebonded to a bonding plane of the wire bonding machine, the clamp insert defining an aperture through which the wire bonding tool may bond wires to the device.

9. The wire bonding machine of claim 8 wherein sidewalls of the clamp insert adjacent the aperture are angled, thereby providing additional clearance for operation of the electronic flame-off wand.

10. The wire bonding machine of claim 8 wherein edges of the clamp insert adjacent the aperture are radiused, thereby providing additional clearance for operation of the electronic flame-off wand.

11. An electronic flame-off wand configured to heat an end portion of a wire extending from a bonding tool of a wire bonding machine to form a free-air ball for bonding, the electronic flame-off wand comprising:
a support structure;
a wand supported by the support structure; and
an actuator configured to vertically adjust a position of the wand with respect to the support structure.

12. The electronic flame-off wand according to claim 11, wherein the wand is pivotably connected to the support structure via a wand support arm.

13. The electronic flame-off wand according to claim 11 wherein the actuator comprises a solenoid.

14. The electronic flame-off wand according to claim 11 wherein the actuator is configured to adjust a position of the wand between a raised and a lowered position.

15. The electronic flame-off wand according to claim 14 wherein the raised position is predetermined such that when the wand is in the raised position the wand does not interfere with raising of a clamp insert of a wire bonding machine above a bonding plane of the wire bonding machine, and the lowered position is predetermined such that when the wand is in the lowered position the wand does not interfere with the clamp insert securing a device to be wirebonded.

16. The electronic flame-off wand according to claim 11 further comprising a spring for urging the wand toward a raised position when the actuator is not being actuated, the actuator being configured to lower the electronic flame-off wand when the actuator is being actuated.

17. A method of operating an electronic flame-off wand configured to heat an end portion of a wire extending from a bonding tool of a wire bonding machine to form a free-air ball for bonding, the method comprising the steps of:
lowering a clamp insert of a wire bonding machine to secure a device to be wirebonded; and
lowering, using an actuator, the electronic flame-off wand towards the clamp insert while the clamp insert secures the device to be wirebonded.

18. The method of claim 18 further comprising the step of:
raising the electronic flame-off wand away from the clamp insert such that a raised position of the electronic flame-off wand does not interfere with raising of the clamp insert away from the bond plane.

19. The method of claim 18 wherein the step of raising includes raising the electronic flame-off wand using the actuator.

20. The method of claim 18 wherein the step of raising includes raising the electronic flame-off wand by deactivating the actuator such that a spring urges the electronic flame-off wand toward the raised position.
